(19) United States
(12) Patent Application Publication
(10) Pub. No.: US 2020/0065841 A1
(43) Pub. Date: Feb. 27, 2020

(54) BEACON-TRIGGERED GIFTING AND TEMPORARY MICRO DYNAMIC VIRTUAL SOCIAL COMMUNITIES WITHIN A RETAIL ENVIRONMENT

(71) Applicant: Me 2 U Inc., Napa, CA (US)

(72) Inventor: Rudy Hernandez, Napa, CA (US)

(21) Appl. No.: 16/612,684

(22) PCT Filed: May 10, 2018
(86) PCT No.: PCT/US2018/032173

§ 371 Date: Nov. 11, 2019

Related U.S. Application Data
(60) Provisional application No. 62/505,106, filed on May 11, 2017.

(51) Int. Cl. G06Q 30/02; G06Q 30/06; G06Q 50/00; G06Q 20/34

(52) U.S. Cl. CPC G06Q 30/0207; G06Q 20/342; G06Q 50/01; G06Q 30/0601

(57) ABSTRACT

Systems and methods are provided for implementing the exchange of electronic gift cards. A purchaser may purchase an electronic gift card and specify a recipient (400). The recipient may receive an initial notification of the gift (402), which excludes a portion of the gift description. The recipient may receive a supplemental notification (408) providing the excluded portion of the gift description, when the recipient's personal electronic device (130) detects the presence of a wireless beacon (120) within one or more redemption locations. The recipient may be prompted to accept or reject the gift (410), and/or to submit thank you content at the time of gift delivery (414), which may be relayed to the purchaser via direct messaging and/or social media. The wireless beacons (120) may also be utilized for providing personalized retailer services, and forming temporary micro dynamic virtual social communities (620, 621, 622).

### BACKGROUND

The present invention relates in general to sales and marketing in a retail environment, and in particular, to location-triggered electronic retailing transactions such as gift card conveyance and in-store virtual interactions amongst shoppers and retailers.

As access to Internet-enabled portable electronic devices has become pervasive, consumers are increasingly shifting to online shopping as a platform for retail transactions. Many brick-and-mortar retailers suffer as a result. Therefore, brick and mortar retailers may desire to provide innovative and engaging retail experiences to encourage customers to visit their retail locations to purchase goods and services.

Meanwhile, gift cards continue to be a popular item for gifting amongst people. As commerce shifts increasingly online, electronic gift cards have become popular, often delivered by email. However, conventional electronic gift cards may provide an unsatisfactory experience for both the gifter and the recipient. Conventional electronic gift cards often eliminate or inhibit meaningful real-time interaction amongst individuals involved in a gift exchange. The lack of control over time and location of gift receipt may also mean that the social context of the gift receipt is unmanaged, oftentimes resulting in suboptimal circumstances for a gift exchange. For example, a person may receive an email gift while busy, distracted or under stress at work, where the email represents another unwanted distraction rather than a pleasant surprise. These and other issues with traditional electronic gift card exchanges may impair the intended positive impact of the gift.

### SUMMARY

In accordance with one aspect, methods are provided for implementing the exchange of electronic gift cards, in which local area wireless beacons may be used as a location-specific trigger for delivery of gift information to a recipient. An electronic gift card purchase may be initiated by a purchaser via interaction with a gift card service comprising one or more network-connected servers. The gift card service may transmit an initial gift notification to a recipient personal electronic device associated with a recipient (e.g., via email, SMS, social media messaging, in-app notification, or the like). The initial gift notification may include information such as identification of the purchaser, and information descriptive of one or more redemption locations at which a supplemental gift notification may be delivered. Preferably, the initial gift notification excludes some element of additional description of the gift, which is to be later provided in the supplemental gift notification. Subsequently, the recipient personal electronic device may operate to detect the presence of a nearby wireless beacon that is associated with one of the one or more redemption locations. The recipient personal electronic device may report the beacon detection to one or more of the servers associated with the gift card service. The gift card service may then transmit a supplemental gift notification to the recipient personal electronic device. The supplemental gift notification may include additional description of the gift, that was excluded from the initial gift notification, such as a gift dollar amount, a type of item for which the gift may be redeemed, or an identification of a retailer at which the gift card may be redeemed.

In some embodiments, a first recipient notification of a gift may be triggered by detection of a beacon associated with a redemption location. Thus, a “surprise” gift may be delivered to a recipient, triggered by their presence in a particular location, such as a retailer at which the gift card may be redeemed.

In some embodiments, upon delivery of a supplemental (or final, surprise) gift notification, the recipient may be queried for acceptance or rejection of the gift card. Upon acceptance of the gift card, value associated with the gift card may be delivered to a gift card wallet associated with the recipient, which wallet may be maintained by the gift card service. The recipient may later be provided with reminders of the gift card availability. Upon rejection of the gift card, value associated with the gift card may be returned to the purchaser, such as via delivery of the gift card value to a mobile wallet associated with the purchaser. In some embodiments, upon rejection of the gift card by the initial recipient, the purchaser may be further queried for identification of a new recipient. In some embodiments, if a recipient does not use a gift card within a predetermined period of time, the gift may be returned to the purchaser by transferring the gift card from the gift card wallet associated with the recipient to the gift card wallet associated with the purchaser.

In some embodiments, immediately upon acceptance of a gift card (e.g., preferably during the same user interaction during which the gift card is accepted), the recipient may be queried to provide thank you note content for conveyance to the gift sender (e.g. text, images, video content, audio content, or combinations thereof). The provided thank you note content may then be transmitted to an electronic account associated with the gift sender, such as a direct messaging account of the gift sender or to a social media account that is accessible to the gift sender.

In some embodiments, interim gift notifications may be transmitted to a recipient, subsequent to the initial notification and prior to the final, supplemental notification. The interim gift notifications may be triggered by detection of the presence of a nearby wireless beacon associated with an interim location.

In some embodiments, upon detection of beacon associated with a retailer location by a recipient's personal electronic device, the gift card service may transmit to a retailer electronic device, a notification of the presence of the recipient's personal electronic device at a retailer location associated with the wireless beacon. The notification may include information such as the identity of the recipient, shopping history, loyalty account information, and/or the availability of gift cards within a recipient gift card wallet.

In some embodiments, detection of a wireless beacon by a user's personal electronic device may be utilized to determine a user's qualification to be in a location-based, temporary micro dynamic virtual social community (TMDVSC). Presence within a TMDVSC may be used to, e.g., qualify a user for access to digital services and/or impact the nature of digital services provided to the user. For example, a TMDVSC may be provided with social media interaction features exclusive to members of the TMDVSC. In other use cases, a user's presence within a TMDVSC may be utilized to qualify a user for access to certain digital services, such as a media streaming service.

Details of these and other aspects of the disclosed embodiments are described in further detail herein.

### BRIEF DESCRIPTION OF THE DRAWINGS

FIG. 1 is a schematic block diagram of a retail environment.

FIG. 2 is a schematic block diagram of a computing environment.

FIG. 3A is a schematic block diagram of a server.

FIG. 3B is a schematic block diagram of a personal electronic device.

FIG. 4A is a flowchart illustrating a process for location-triggered gift card delivery in a retail environment.

FIG. 4B is a flowchart illustrating another process for location-triggered gift delivery in a retail environment.

FIG. 5 is a process for location-triggered retailer-consumer communications and reporting.

FIG. 6 is a schematic representation of temporary micro dynamic virtual social communities.

FIG. 7 is a schematic block diagram of a computing environment implementing temporary micro dynamic virtual social communities.

### DETAILED DESCRIPTION OF THE DRAWINGS

While this invention is susceptible to embodiment in many different forms, there are shown in the drawings and will be described in detail herein several specific embodiments, with the understanding that the present disclosure is to be considered as an exemplification of the principles of the invention and is not intended to limit the invention to the embodiments illustrated.

In accordance with some embodiments, location-based retail systems and services may be provided to drive consumers into retail locations, enhance in-store consumer experience, and/or provide retailers with greater visibility and insight into consumer behavior. A cloud-based Internet service and associated mobile app or websites may permit consumers to purchase gift cards (e.g. for use with retailers, food providers, service providers or the like). The gift cards may then be conveyed to other users of the service, individuals associated with the sender as a friend or other relationship within a social networking service (such as Facebook, Instagram, Snapchat or Twitter), or a contact address such as email address or SMS number.

After a gift is purchased, an initial gift notification may be sent to prompt the recipient to install a mobile app associated with the gift service onto the recipient's mobile device. The initial notification, or subsequent notifications, may provide the recipient with varying amounts of information about the gift, such as information about the sender and hints or information regarding particular locations at which the gift details may be delivered. Thus, participation may benefit brick-and-mortar retailers by, for example, driving gift recipient foot traffic to their retail locations.

When the user subsequently visits a wireless beacon with which the gift is associated (such as a physical store location of a particular retailer), the recipient can then be surprised with a mobile device notification indicating the gift details, such as the amount of the gift.

Various other mechanisms for detecting a user's presence at a target location for delivery of gift information may be used. For example, many mobile phones or similar devices include a GPS receiver for determining device location; geofencing techniques can be utilized to determine when a device enters a target area. In other circumstances, general location may be determining by identification of WiFi and/or cellular data networks present in an area. However, such location services may be limited, in some circumstances. For example, many location services may provide limited precision, perhaps identifying a shopper's presence in a shopping mall, but without being able to accurately identify the shopper's arrival at a specific store within the mall, or a specific department or location within a store. Many location services are also ineffective and/or inaccurate indoors, which is a typical setting for a retail environment. Reliably triggering a surprise gift at a precise location within a retail environment, may amplify the gift impact and emotional response of the recipient. Thus, in other embodiments, as described further herein, wireless beacons may be utilized to trigger gift delivery and other interactions at precise locations.

Upon receiving a gift notification, the recipient may choose to accept or reject the gift. If accepted, the recipient may immediately thank the giver, via a social media platform communications or app-to-app messaging via the gift card platform. Facilitating real-time, in-the-moment thank-you messaging in this portion of the gifting context may promote more timely and authentic communications. Also, sending of thank you communications via social media may provide valuable publicity for a retailer associated with the gift, as well as opportunities for the retailer to “augment” a gift with additional credit, coupons or promotions.

Once accepted, gift card value may be maintained in a mobile device wallet, enabling future reminders. Gift cards may be rendered on a mobile device display screen and scanned by a retailer to complete a purchase transaction, similar to scanning of physical gift cards for redemption.

The platform may also be used to provide retailers with real-time access to information about consumers present at their retail locations. Users can opt in to providing information to retailers. Opting in to receiving surprise location-based notifications may also enable retailer reporting. Detection of user presence near beacons may then be used to generate retailer reporting of consumer presence, identity and profile information. Such consumer presence reporting may then be used to provide, e.g., enhanced in-person customer service, recognition of customer loyalty, and highly targeted and timely advertising and promotional messaging.

Retail Computing Environment

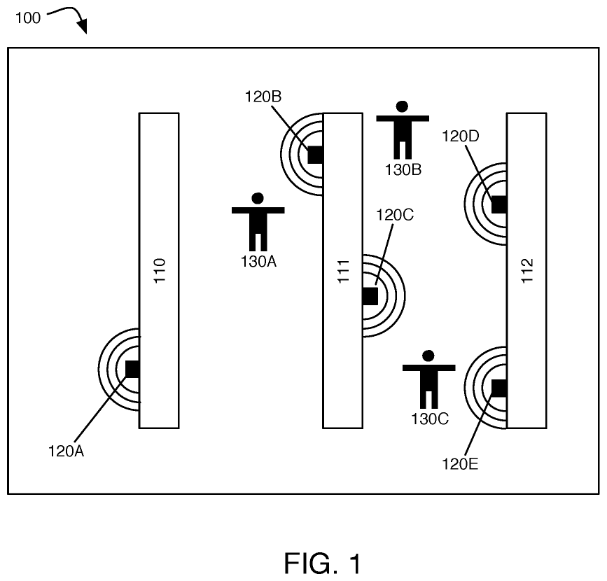

FIG. 1 is a schematic representation of an exemplary retail establishment in which certain embodiments may be implemented. Establishment 100 includes multiple product display shelves 110, 111 and 112. A number of wireless beacons 120 are distributed throughout establishment 100, including beacons 120A, 120B, 120C, 120D and 120E. Each beacon 120 has a unique identifier associated with it, and is positioned at a known location within establishment 100. For example, beacons 120 may be installed on or below predetermined product shelves, installed at a shelf endcap, mounted on a store ceiling, or attached to (or embedded within) a light fixture. Each beacon 120 includes a short range wireless transmitter, such as a Bluetooth Low Energy transmitter, periodically transmitting messages that may be detected by nearby electronic devices, such as smartphones. In some embodiments, beacons 120 may operate in accordance with the Apple iBeacon and/or Google Eddystone standards. In other embodiments, each beacon 120 may include a transceiver adapted for bidirectional wireless communications with nearby devices. In either case, each beacon 120 provides wireless communications that may be used by nearby devices to determine their proximity thereto.

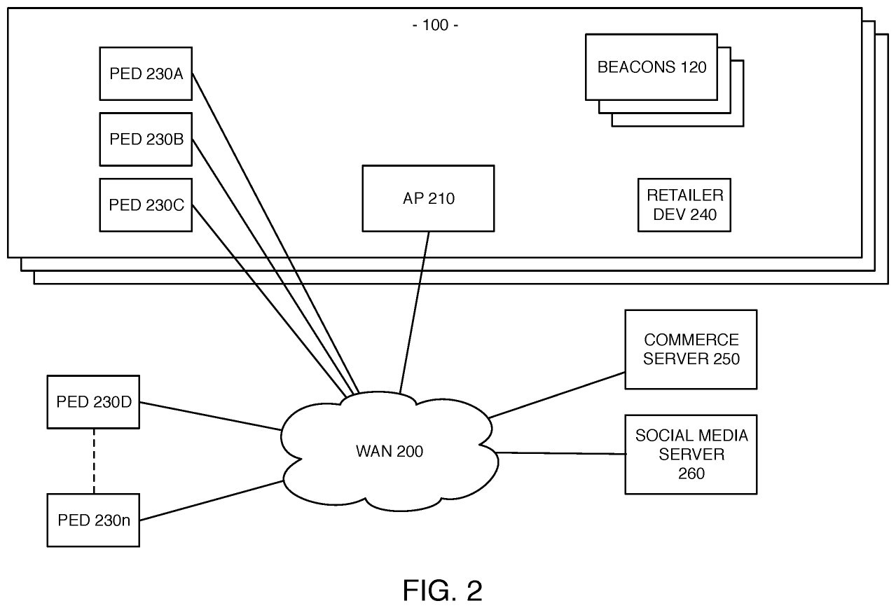

Retail establishment 100 may be occupied by several consumers 130, including consumer 130A, consumer 130B and consumer 130C. Each consumer carries with them one or more personal electronic devices (“PEDs”) 230 (shown in FIG. 2). For example, consumer 130A carries PED 230A, consumer 130B carries PED 230B, and consumer 130C carries PED 230C. PEDs 230 may include, without limitation, smartphones, tablet computers, laptop computers, smart watches, smart glasses, or various other wearable or portable electronic devices. Each PED 230 includes a wireless communication module adapted for communications via a wireless communication protocol also utilized by beacons 120, such as Bluetooth Low Energy.

FIG. 2 is a schematic illustration of a computing environment in which some embodiments may be implemented. Various devices communicate via wide area network 200, which may include the Internet. One or more retail establishments 100 may each contain multiple in-store personal electronic devices (e.g. PEDs 230A, 230B, 230C), multiple beacons 120, one or more retailer electronic devices 240, and one or more wireless networking access points 210. The environment may also include one or more out-of-store consumer PEDs 230D through 230n. Commerce server 250 implements various functionality described further herein. One or more social media services may be implemented and accessed via WAN 200, including social media server 260.

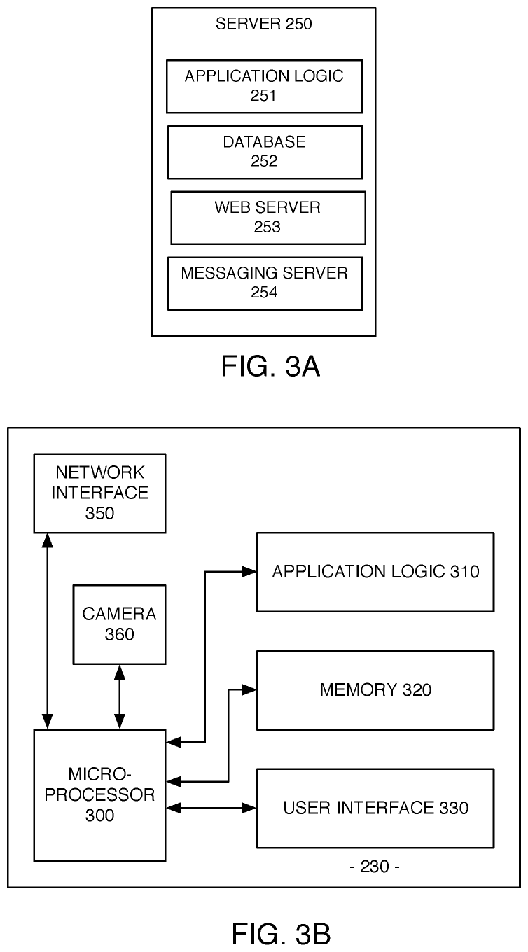

FIG. 3A is a schematic block diagram of retail commerce server 250. Server 250 implements application logic 251, and operates to store information within, and retrieve information from, database 252. The term “database” is used herein broadly to refer to an indexed store of data, whether structured or not, including without limitation relational databases and document databases. Web server 253 hosts one or more Internet web sites enabling outside user interaction with, amongst other things, application logic 251 and database 252. Messaging server 254 enables messaging, such as mobile network messaging service (e.g. SMS or MMS), email, or application notifications, between server 250 and, e.g., PEDs 230.

While depicted in the schematic block diagram of FIG. 3A as a block element with limited sub elements, as known in the art of modern web applications and network services, server 250 may be implemented in a variety of ways, including via distributed hardware and software resources and using any of multiple different software stacks. Server 250 may include a variety of physical, functional and/or logical components such as one or more each of web servers, application servers, database servers, email servers, SMS or other messaging servers, and the like. That said, the implementation of server 250 will include at some level one or more physical servers, at least one of the physical servers having one or more microprocessors and digital memory for, inter alia, storing instructions which, when executed by the processor, cause the server to perform methods and operations described herein.

FIG. 3B is a schematic block diagram of an exemplary personal electronic device (PED) 230, such as a smartphone, tablet or other mobile computing device, that may be used in some embodiments to engage in various operations described herein. PED 230 includes microprocessor-based controller 300, application logic 310, digital memory 320, user interface components 330, network interface 350, and digital camera module 360. User interface components 330 may include a touch-sensitive display screen, as is typical of a smartphone or tablet computer. Other embodiments of user interface components 330 may include, without limitation, non-touch sensitive display screens, physical and/or virtual keyboards, pointing devices, and styluses. Microprocessor 300 implements application logic 310 to interact with user interface components 330, camera 360 and network interface 350, and to perform various other functions described further elsewhere herein.

Location-Enabled Electronic Gift Cards

A cloud-based Internet service and associated mobile app or websites may permit consumers to purchase gift cards (e.g. for use with retailers, food providers, service providers or the like) with delivery of the gift or information relating thereto triggered by recipient localization proximate a retailer, or proximate a specific location within a given retailer's establishment. The gift cards may then be conveyed to other users of the service, individuals associated with the sender as a friend or other relationship within a social networking service (such as Facebook, Instagram, Snapchat or Twitter), or a contact address such as email address or SMS number.

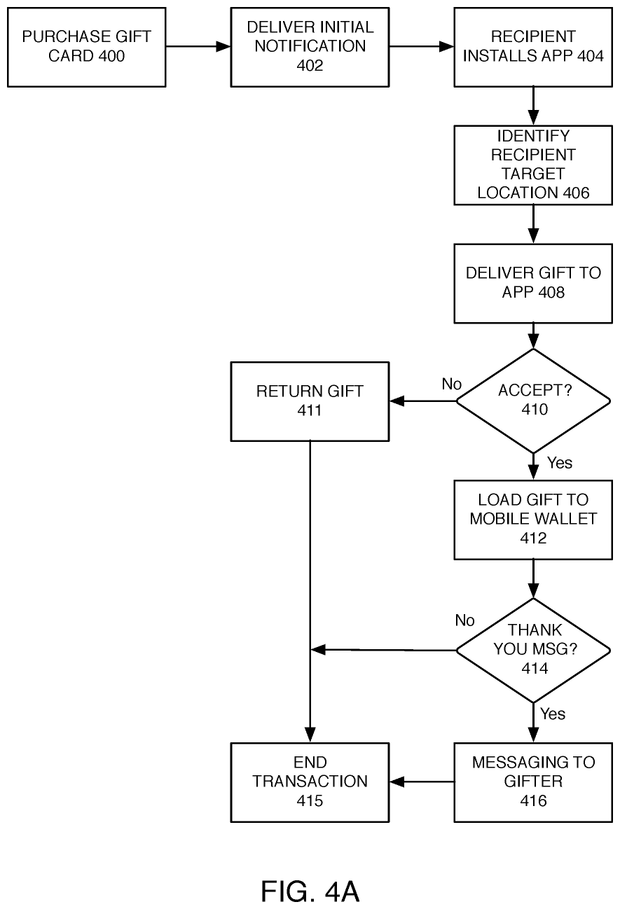

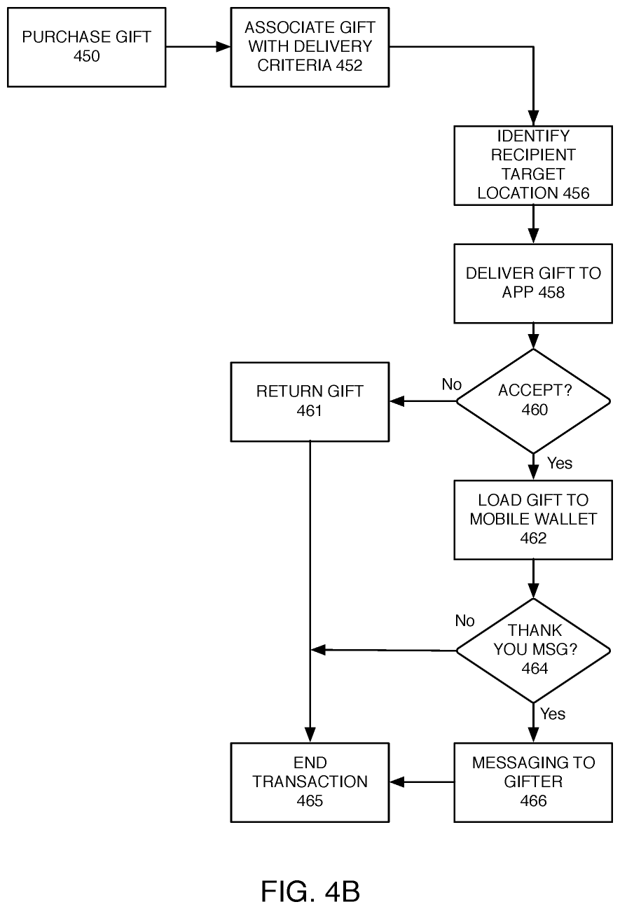

FIG. 4A is a process for implementing such gift cards in the environment of FIGS. 1-3. In step 400, a gift is purchased by a giver for a recipient. The giver may utilized a PED to purchase the gift, such as via a computing device implementing a web browser application to access an ecommerce web site hosted by server 250 (including web server 253), or a smartphone mobile app accessing a backend ecommerce service hosted by server 250. After a gift is purchased, an initial gift notification may be sent in step 402 to the recipient's PED, to notify the recipient of the gift. The initial notification, or subsequent notifications, may provide the recipient with varying amounts of information about the gift, such as information about the sender and hints or information regarding particular locations at which further gift details may be delivered.

Typically, locations for triggering delivery of gift details will be a retail establishment, having beacons 120 installed therein. The triggering location, as specified in the initial notification, may be a specific retail location (e.g. a coffee shop nearby a user's home). The triggering location may be any location associated with a particular retailer (e.g. any Starbucks coffee shop). The triggering location may be specified by retailer type (e.g. inside any participating coffee shop). The triggering location may also be tied to a particular area of a retailer's establishment (e.g. near any Macy's department store makeup counter). The triggering location may be various combinations of such location criteria, or other location criteria.

The initial notification preferably also prompts the recipient to install a mobile app associated with the gift service onto the recipient's mobile device, if the app is not already installed (step 404). The mobile app may utilize device location services to report user location back to server 250. The mobile app may also utilize beacon services, such as Apple iBeacon and/or Google Eddystone services, to detect wireless beacons present in the location environment of an associated PED.

When the user subsequently visits a wireless beacon with which the gift is associated (such as a physical store location of a particular retailer), the recipient can then be surprised with a mobile device notification indicating the gift details, such as the amount of the gift. Specifically, in step 406, a user's PED 230 (implementing the mobile app) detects a nearby beacon within a retail establishment using iBeacon services, which reports the beacon detection to server 250 via WAN 200 (step 406). In step 408, server 250 transmits a final supplemental gift notification back to PED 230, with details concerning the nature and amount of the gift. The final supplemental notification in step 250 may be via, for example, mobile app notification or SMS.

Reliably triggering a surprise gift at a precise location within a retail environment, may amplify the gift impact and emotional response of the recipient. In some use cases, the intended gift may be available for retail acquisition immediately at the location of the final gift notification, thereby increasing the recipient's excitement at receiving the gift. For example, should a giver wish to gift a $250 electronic device to a recipient, an electronics retailer gift certificate for $250 may be delivered to the recipient in response to the recipient visiting a retailer, and specifically a location within the retailer at which the intended gift is displayed.

In some embodiments, additional interim messages may be delivered, in addition to the initial notification of step 402 and delivery messaging in step 408. Some interim messages may be location-based, triggered in response to beacon detection and/or other geolocation techniques, such as “Getting closer!” or “You're near a juice shop—feeling thirsty?”. Other interim messages may be time-based (e.g. periodic reminders). Other interim messages may be triggered by other criteria (e.g. “It's hot out today. How about some ice cream?” when local temperature exceeds a threshold level).

In some embodiments, upon receiving a final gift notification in step 408, the recipient may choose to accept or reject the gift (step 410). The gift acceptance or rejection may be expressed via interaction with recipient PED 230. For example, if a final gift notification is delivered in step 408 via mobile in-app messaging, the app may include user interface elements querying the user for acceptance. If a final gift notification is delivered in step 408 via SMS, the user may be prompted for return SMS indicating acceptance or rejection of the gift. Enabling the recipient to accept or reject a gift may be particularly important for certain social circumstances in which the platform may be used. For example, systems and methods described herein may be applied in the context of an online dating site, in which a gift may be offered to a person with whom the giver would like to further their relationship. The recipient may wish to have the option to reject the gift, in the event that the recipient is not interested in furthering a relationship with the giver.

If the gift is rejected, server 250 transmits a return notification to the giver, and the value of the gift may be returned to the giver (step 411), upon which the transaction is terminated (step 415). In some embodiments, return of a gift to the gift giver in step 411 may further include querying the gift giver for identification of another individual as a subsequent recipient for the gift; in such embodiments, the gift process may be repeated for the new recipient (e.g., in the embodiment of FIG. 4A, by returning to step 402 with the newly-specified recipient).

If accepted, server 250 loads the gift value into a digital wallet associated with the recipient (step 412). The digital wallet may be accessed via mobile app operating on PED 230. The mobile app may render a gift card on a PED, e.g. by displaying QR codes, bar codes or the like, for scanning by the retailer point of sale system and utilization of the gift value similarly to a physical gift card.

The recipient may be presented with an option to immediately thank the giver. Facilitating real-time, in-the-moment thank-you messaging in this portion of the gifting context may promote more timely and authentic communications. Also, sending of thank you communications via social media may provide valuable publicity for a retailer associated with the gift, as well as opportunities for the retailer to “augment” a gift with additional credit, coupons or promotions. In step 414, the recipient is prompted (e.g. via mobile app displays on PED 230, or via interactive chat agent) to thank the gift giver. If the recipient declines, the transaction is completed (step 415).

If the recipient elects to thank the gift giver, thank you messaging and communication avenues may be specified in step 416, such as via interaction between the recipient PED and a gift card service server. For example, user interface elements presented to the recipient via the recipient PED may prompt the recipient to choose between communicating thanks via social media platform communications (by interaction between PED 230 or commerce server 250, with social media server 260), or via app-to-app messaging (implemented between commerce server 250, the recipient PED and the giver PED). In some embodiments, step 414 may enable capture of thank you note content via one or more different forms of media that may be captured by the recipient PED, including, without limitation: text entered on a physical or virtual PED keyboard; a photograph captured by an integrated PED camera or selected from amongst images previously stored; audio content (spoken or otherwise) captured by an integrated PED microphone; and/or video content captured by an integrated PED camera or selected from amongst video clips previously stored. For example, photo or video-based thank you content may be utilized to show a gift giver an item that was purchased using the gift card, or an experience purchased using the gift card. Preferably, such thank you content may be captured and transmitted to the gift giver promptly at the time of purchase (e.g. during the same shopping trip, during the same retailer visit during which the final gift details were conveyed, and/or during the same retailer visit during which the gift card was used to make a purchase), thereby facilitating authentic recipient reaction to the gift. In some embodiments, a thank you note posted to social media

Once a gift is accepted, server 250 may deliver future reminders to the recipient's PED to prompt the recipient to use any unused gifts. Reminders may be time-based (e.g. delivered periodically). Reminders may additionally or alternatively be delivered based on recipient location. For example, if an individual visits a location associated with a previously-delivered, unused gift card, the user's PED may deliver a notification reminding the user that the gift is available for use nearby.

While the process of FIG. 4A contemplates an initial gift notification to the recipient, in some circumstances, it may be desirable to enable givers to provide “surprise” gifts that are first presented to recipients when the recipient visits an associated retail location. Particularly for locations that a recipient is known to frequent and in circumstances where the desired timing of first notice is flexible, this approach may provide even greater emotional resonance for the gift recipient, as an unexpected surprise. FIG. 4B illustrates an example of such a process. In step 450, a gift item is purchased (e.g. via communication that includes commerce server 250, and potentially retailer e-commerce servers), and the gift transaction is configured for first recipient notification upon identifying the recipient's presence in a particular location or set of locations. In step 452, commerce server 250 stores gift details within database 252, including identification of beacons at locations corresponding to desired gift delivery. In step 456, the recipient's location is identified as satisfying gift delivery criteria. In step 458, the recipient is notified of the gift details (analogously to step 408). Remaining steps 460-466 are analogous to steps 410-416 in FIG. 4A.

Various examples described hereinthroughout refer to purchase and delivery of a gift card. The concept of a gift card that may be delivered in accordance with embodiments described herein includes, but is not limited to, a traditional stored-value mechanism having a starting economic value defined by the purchaser. However, it is contemplated and understood that in some embodiments, gift cards may include other types of gifts, such as a voucher or merchant credit for a specific good or service, or a recipient selection from amongst predetermined options for goods or services.

Retailer Services

The platform may also be used to provide retailers with real-time access to information about consumers present at their retail locations. Users can opt in to providing information to retailers, e.g. via a user setting specified on a PED mobile app. Opting in to receiving surprise location-based gift notifications may also effectively enable retailer reporting. Detection of user presence near beacons may then be used to generate retailer reporting of consumer presence, identity and profile information.

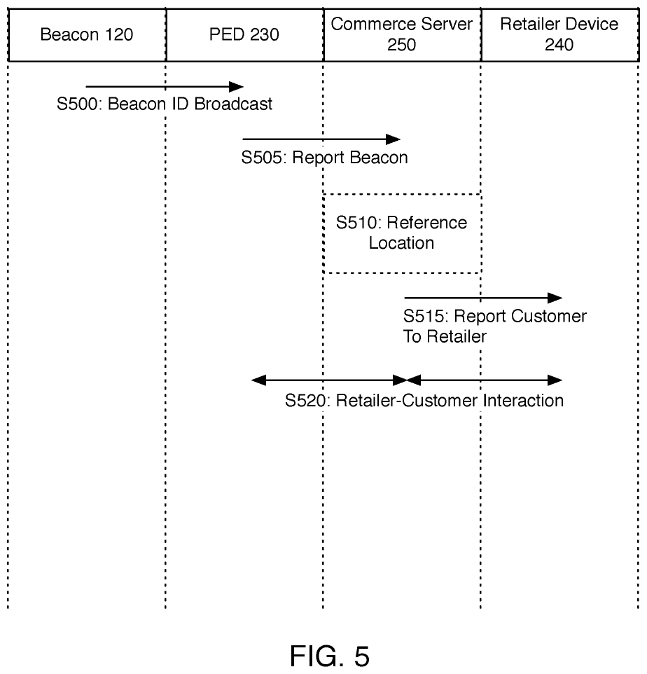

FIG. 5 illustrates an exemplary process for implementing retailer services. In step S500, one or more beacons 120 broadcast short range wireless signals within retail establishment 100. In step S505, a customer PED 230 detects one or more beacon signals from step S500, and reports the beacons to commerce server 250. In step S510, commerce server 250 references location and/or retailer information associated with the detected beacon, towards identifying the customer's current location. In step S515, commerce server 250 conveys the customer's identity, current location, and optionally other associated information, to retailer device 240.

In some embodiments, retailer device 240 may be a mobile computing device used by retailer employees, such as a tablet computer implementing functionality described herein via a mobile app operating thereon. In other embodiments, retailer device 240 may include a retailer computing system, such as a retailer-associated server communicating with one or more in-store PEDs via a data network.

Such consumer presence reporting may then be used to provide, e.g., enhanced in-person customer service, recognition of customer loyalty, and highly targeted and timely advertising and promotional messaging. For example, retail customer service associates can approach a customer with knowledge of their name, purchase history, preferences, gift cards available within the customer's gift card mobile wallet, etc., all reported from commerce server 250 and/or stored within retailer computing systems. Such implementations may facilitate a gift card recipient with utilizing a newly-received or previously-received gift card that is redeemable at a retailer location currently occupied by the recipient.

Temporary Micro Dynamic Virtual Social Communities

Use of beacon-enabled PEDs by consumers may also give rise to new social networking and interaction opportunities that are highly relevant to a user's current location, interests and activities. One such example is implementation of temporary micro dynamic virtual social communities (TMDVSCs). A TMDVSC may be a technology-enabled community with membership selected based on an individual's current location. Individual location may be determined via beacon reporting, thereby enabling highly localized communities, even within retail establishments or other indoor locations in which GPS and AGPS location services may be inaccurate or unavailable. Social networking and other communication services may then be implemented amongst members of a TMDVSC. When an individual leaves the location associated with the TMDVSC, their membership is revoked and they are no longer able to access the TMDVSC.

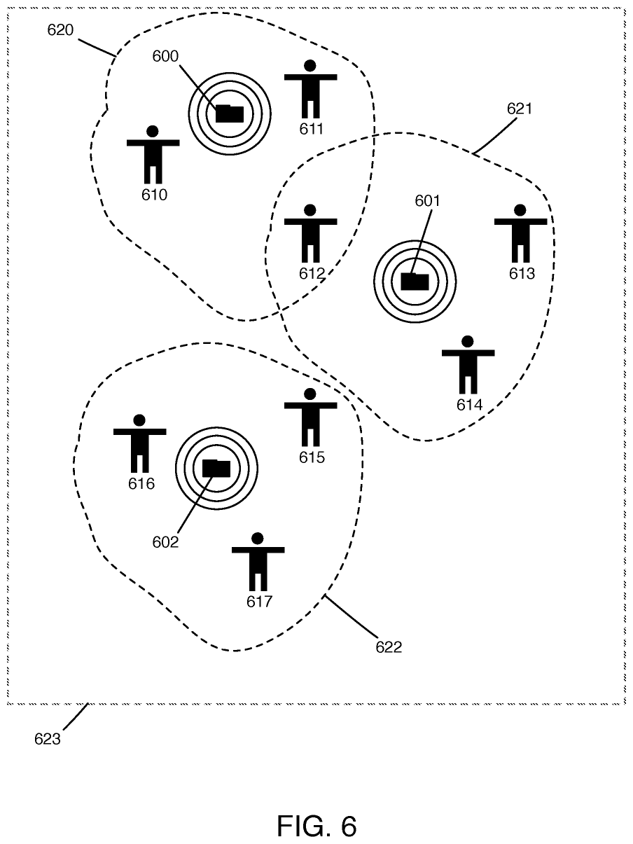

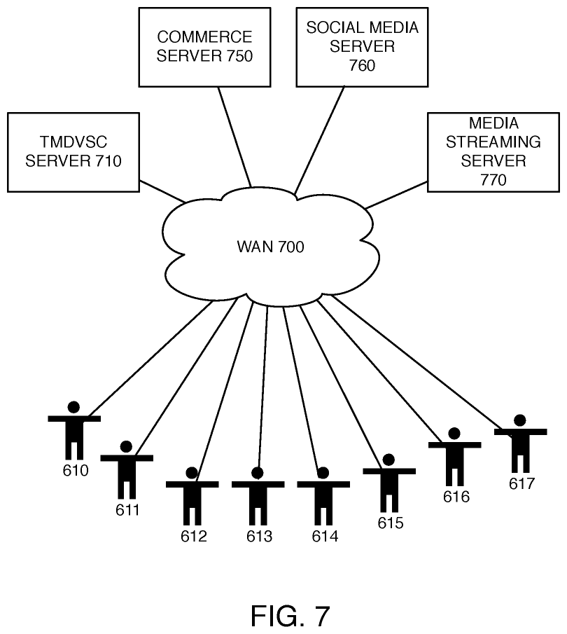

FIGS. 6 and 7 illustrate an exemplary implementation of a TMDVSC within a retail environment 623. Retail environment 623 includes three wireless beacons 600, 601 and 602. Eight user personal electronic devices 610-617 are configured for communication with a TMDVSC server 710 via WAN 700. PEDs 610-617 are physically present within environment 623. Consumer devices 610, 611 and 612 are proximate to, and detect a signal emitted by, beacon 600. Consumer devices 612, 613 and 614 are proximate to, and detect a signal emitted by, beacon 601. Consumer devices 615, 616 and 617 are proximate to, and detect a signal emitted by, beacon 602. Device proximity to each beacon may be reported to TMDVSC server 710 in accordance with a process analogous to that of FIG. 5. PEDs 610-617 and/or TMDVSC server 710 may communicate with one or more other servers providing network-based services, such as commerce server 750, social media server 760, and media streaming server 770. While TMDVSC server 710 is illustrated separately in the embodiment of FIG. 7, it is contemplated and understood that in some embodiments, the functionality of TMDVSC server 710 may be integrated with another server, such as commerce server 750 or social media server 760.

A TMDVSC server may utilize beacon reporting to control the availability of network-based services to consumer devices via interaction with other servers or network services. For example, within facility 623, a first TMDVSC 620 may be formed around beacon 600, including devices 610, 611 and 612. A second TMDVSC 621 may be formed around beacon 601, including devices 612, 613 and 614. A third TMDVSC 622 may be formed around beacon 602, including devices 615, 616 and 617. In some embodiments, a TMDVSC server may then make a network service available only to users within a specific TMDVSC (e.g., users having devices reporting a common beacon unique identifier). In some embodiments, a TMDVSC server may make services available to users within multiple TMDVSCs. In some embodiments, a TMDVSC server may make services available to users within multiple TMDVSCs, but implementation of the service may vary depending on the particular TMDVSC within which a device is present. In some embodiments, TMDVSC server 710 may report user authentication for PEDs 610-617 to other services (such as, without limitation, commerce server 750, social media server 760, or media streaming server 770) to authenticate a user's qualification within a particular TMDVSC, which authentication may be utilized by such other services in controlling how such other services are provided.

For example, it may be desirable to implement a TMDVSC within a coffee shop. Customers of the coffee shop may then use desirable social networking constructs to facilitate interaction between customers currently present at the store, as well as interactions between the retailer and its currently-present customers. Social media services that may be desirable for implementation within a TMDVSC include, without limitation, individual profile pages, retailer profile pages, direct messaging, broadcast messaging, media sharing, message boards, content feeds, and the like.

Thus, for example, coffee shop patrons may utilize the TMDVSC to view profiles for other individuals currently within the establishment, to identify individuals sharing common interests or having skill sets of interest, thereby promoting in-person customer interaction and enriching the customer experience.

As another example, the coffee shop establishment may provide a TMDVSC community page widget that broadcasts the artist name, album name and song title of music currently playing within the establishment.

Retailers may also utilize TMDVSCs to offer desirable services to individuals present within their establishments. For example, a coffee shop may offer a music streaming service membership implemented by media streaming server 770, that is available to members of an in-store TMDVSC; thus, customers may listen to desired music on-demand while present in-store, with music streaming service user authentication dependent upon TMDVSC membership. Retailers may also make media content or other information available exclusively via a TMDVSC, such as providing streaming or download access to a new music album exclusively to individuals visiting a retailer (and thereby joined as members of a TMDVSC).

Retailers may also utilize TMDVSCs for implementing technology-based customer service solutions. A retailer information system may feed beacon-based precise in-premises customer localization as an input to a customer-service technology solution implemented by, e.g., commerce server 750. For example, a retailer may implement a chat bot to interact with in-store customers via their mobile devices. The TMDVSC chat bot may be utilized to provide intelligent in-store wayfinding (e.g. directing a customer “straight ahead” or “two aisles over” to locate a desired item). The TMDVSC chat bot may answer questions concerning products in the customer's current vicinity. The TMDVSC chat bot may be utilized to provide a first level of sales support to customers, while automatically escalating requests for human assistance, with precise customer location and identity, in the event that the chat bot is unable to resolve the in-store customer's concern. Such approaches may enable retailers to provide improved customer service and customer satisfaction, with reduced human staffing levels, particularly within big box retailers and other large establishments.

A TMDVSC service provider may create logical and community rules (TOA's) regarding consumer-to-consumer interactions, group messages and retailer engagements.

In some embodiments, a TMDVSC may be implemented using the computing environment of FIGS. 1-3, and the process of FIG. 5, whether integrated within an electronic gift card service or otherwise. TMDVSC services (such as managing TMDVSC membership and providing social networking functions amongst members and an associated retailer) may be implemented by, e.g., commerce server 250. Interactions in step S520 may be between customer devices 230 and commerce server 250, as well as between retailer device 240 and commerce server 250. TMDVSC services may be provided via, e.g., a web site implemented by web server 253, and/or a mobile application installed on PEDs 230 and retailer device 240, interacting with an API or other service gateway implemented by commerce server 250.

A TMDVSC may also be used to facilitate gifting transactions. A TMDVSC member may use a PED to initiate a gift of a product or service provided by the TMDVSC host merchant, similarly to the process described above. Because the giver is present within the associated retail establishment at the time of the transaction, the establishment's Point-Of-Sale system may be utilized to complete the purchase. An initial notification, and optionally one or more subsequent hints, may be delivered to the recipient to encourage the recipient to visit the establishment associated with the gift and join the TMDVSC. When the recipient joins the TMDVSC with which the gift is associated, the gift may be delivered to the recipient (analogous to step 408). The retailer may then locally present the gifted product or service to the recipient, then on-site.

While certain embodiments of the invention have been described herein in detail for purposes of clarity and understanding, the foregoing description and Figures merely explain and illustrate the present invention and the present invention is not limited thereto. It will be appreciated that those skilled in the art, having the present disclosure before them, will be able to make modifications and variations to that disclosed herein without departing from the scope of any appended claims.

1. A method for implementing the exchange of electronic gift cards, comprising:
initiating an electronic gift card purchase by a purchaser via interaction with a gift card service comprising one or more network-connected servers;
transmitting, by the gift card service, an initial gift notification to a recipient personal electronic device associated with a recipient, the initial gift notification comprising: identification of the purchaser, and information descriptive of one or more redemption locations at which a supplemental gift notification may be delivered; wherein the initial gift notification excludes additional description of the gift to be subsequently provided in the supplemental gift notification;
detecting, by the recipient personal electronic device, the presence of a nearby wireless beacon associated with one of the one or more redemption locations, the recipient personal electronic device reporting the beacon detection to one or more of the servers associated with the gift card service; and
transmitting, by the gift card service, a supplemental gift notification to the recipient personal electronic device, the supplemental gift notification comprising the additional description of the gift excluded from the initial gift notification.

2. The method of claim 1, in which the supplemental gift notification comprises a description of a specific dollar amount of the gift card.

3. The method of claim 1, in which the supplemental gift notification comprises a description of an item for which the gift card may be redeemed.

4. The method of claim 1, in which the supplemental gift notification comprises an identification of a retailer at which the gift card may be redeemed.

5. The method of claim 1, further comprising:
at the time of delivery of the supplemental gift notification, querying the recipient for acceptance or rejection of the gift card;
upon acceptance of the gift card, delivering a value associated with the gift card to a gift card wallet associated with the recipient; and
upon rejection of the gift card, delivering a value associated with the gift card to a gift card wallet associated with the purchaser.

6. The method of claim 5, further comprising: periodically transmitting, by the gift card service to the recipient, reminder notifications of one or more gift cards available within the gift card wallet associated with the recipient.

7. The method of claim 5, further comprising:
immediately upon acceptance of the gift card, querying the recipient for entry of thank you note content to the gift sender; and
transmitting the thank you note content to an electronic account associated with the gift sender.

8. The method of claim 7, in which the step of transmitting the thank you note content to an electronic account associated with the gift sender comprises posting the thank you note content to a social media account associated with to the gift sender.

9. The method of claim 7, in which the step of transmitting the thank you note content to an electronic account associated with the gift sender comprises transmitting the thank you note content to a personal electronic device associated with the gift sender via mobile app notification.

10. The method of claim 1, further comprising:
at the time of delivery of the supplemental gift notification, querying the recipient for entry of thank you note content to the gift sender; and
transmitting the thank you note content to an electronic account associated with the gift sender.

11. The method of claim 10, in which the step of transmitting the thank you note content to an electronic account associated with the gift sender comprises posting the thank you note content to a social media account accessible to the gift sender.

12. The method of claim 10, in which the step of transmitting the thank you note content to an electronic account associated with the gift sender comprises transmitting the thank you note content to a personal electronic device associated with the gift sender via mobile app notification.

13. The method of claim 10, in which the thank you note content comprises an image captured by a camera integrated within the recipient personal electronic device.

14. The method of claim 1, further comprising:
detecting, by the recipient personal electronic device, the presence of a nearby wireless beacon associated with one or more interim locations, the recipient personal electronic device reporting the interim location wireless beacon detection to one or more of the servers associated with the gift card service; and
transmitting, by the gift card service, an interim gift notification to the recipient personal electronic device, the interim gift notification comprising information indicative of the one or more redemption locations.

15. The method of claim 5, further comprising:
upon rejection of the gift card, querying the gift giver for identification of a new recipient for the gift.

16. The method of claim 5, further comprising:
upon expiration of a predetermined time period following acceptance of the gift card during which the gift card is not redeemed, returning the gift to the purchaser by the gift card service by transferring the gift card from the gift card wallet associated with the recipient to the gift card wallet associated with the purchaser.

17. The method of claim 1, in which the step of detecting, by the recipient personal electronic device, the presence of a nearby wireless beacon associated with one of the one or more redemption locations, further comprises:
transmitting, from the gift card service to a retailer electronic device, a notification of the presence of the recipient's personal electronic device at a retailer location associated with the wireless beacon, the notification further comprising indication of a gift card available within a recipient gift card wallet available for redemption at the retailer location.

18. A method for delivery of electronic gift cards, comprising:
initiating an electronic gift card purchase by a purchaser via interaction with a gift card service comprising one or more network-connected servers;
specifying, by the purchaser, a recipient and one or more gift delivery locations for delivery of the electronic gift card, each gift delivery location associated with one or more wireless beacons;
detecting, by a personal electronic device associated with the recipient, the presence of at least one of the one or more wireless beacons, the recipient personal electronic device reporting the beacon detection to one or more of the servers associated with the gift card service; and
transmitting, by the gift card service, a surprise gift notification to the recipient personal electronic device, while the recipient electronic device is proximate the one or more wireless beacons, the surprise gift notification comprising identification of the purchaser and description of the gift.

19. The method of claim 18, further comprising:
at the time of delivery of the surprise gift notification, querying the recipient for acceptance or rejection of the gift card;
upon acceptance of the gift card, delivering a value associated with the gift card to a gift card mobile wallet associated with the recipient; and
upon rejection of the gift card, delivering a value associated with the gift card to a gift card mobile wallet associated with the purchaser.

20. The method of claim 19, further comprising:
immediately upon acceptance of the gift card, querying the recipient for entry of thank you note content to the gift sender; and
transmitting the thank you note content to an electronic account associated with the gift sender.

21. The method of claim 20, in which the step of transmitting the thank you note content to an electronic account associated with the gift sender comprises posting the thank you note content to a social media account associated with to the gift sender.

22. The method of claim 20, in which the step of transmitting the thank you note content to an electronic account associated with the gift sender comprises transmitting the thank you note content to a personal electronic device associated with the gift sender via mobile app notification.

23. A method for providing location-based social networking services, comprising:
receiving, by each of a plurality of user personal electronic devices, a unique identifier from each of one or more nearby wireless beacons;
transmitting, by each of the personal electronic devices, the received unique identifiers to a network-connected server via a digital communications network;
providing, by the network-connected server, one or more network services to each personal electronic device, the provided services determined at least in part by each device's transmitted unique identifiers.

24. The method of claim 23, in which the step of providing one or more network services comprises enabling communication amongst a subset of personal electronic devices determined based on the transmitted unique identifiers.

25. The method of claim 24, in which the subset of personal electronic devices consists of personal electronic devices reporting a common beacon unique identifier.

26. The method of claim 22, in which the step of providing one or more network services comprises providing an authentication service authenticating devices based at least in part on the transmitted unique identifiers.

27. The method of claim 22, in which the step of providing one or more network services comprises delivering notifications of electronic gift cards.
